(19) United States
(12) Patent Application Publication
(10) Pub. No.: US 2025/0332719 A1
(43) Pub. Date: Oct. 30, 2025

(54) ROBOT SYSTEM AND MODELING METHOD

(71) Applicant: KABUSHIKI KAISHA YASKAWA DENKI, Kitakyushu-shi (JP)

(72) Inventors: Sae SAKATA, Fukuoka (JP); Yukihiro TOBATA, Fukuoka (JP)

(73) Assignee: KABUSHIKI KAISHA YASKAWA DENKI, Kitakyushu-shi (JP)

(21) Appl. No.: 19/260,610

(22) Filed: Jul. 7, 2025

Related U.S. Application Data
(63) Continuation of application No. PCT/JP2023/000654, filed on Jan. 12, 2023.

(51) Int. Cl. B25J 9/16

(52) U.S. Cl. CPC B25J 9/163; B25J 9/1694

(57) ABSTRACT

A robot system includes: a sensor configured to acquire three-dimensional data of an object disposed in a real space; a robot configured to change a position of the sensor; circuitry configured to: recognize, based on three-dimensional first data acquired by the sensor, an empty region in the real space where the object does not exist; control the robot so as to dispose the sensor in the empty region; and model the real space based on recognized empty regions including the empty region and a new empty region, the new empty region recognized based on three-dimensional second data newly acquired by the sensor from the empty region.

### CROSS-REFERENCE TO RELATED APPLICATIONS

This application is a continuation application of PCT Application No. PCT/JP2023/000654, filed on Jan. 12, 2023. The entire contents of the above listed PCT and priority applications are incorporated herein by reference.

### BACKGROUND

### 1. Field

The present disclosure relates to a robot system and a modeling method.

### 2. Description of the Related Art

Japanese Unexamined Patent Publication No. 2022-070079discloses a control device including a motion control means for controlling a robot so as to move the measurement range of a three-dimensional sensor, and a map acquisition means for updating map information indicating the exploration status of each point in an exploration region based on the measurement result of the three-dimensional sensor. The motion control means executes a first exploration process for moving the measurement range of the three-dimensional sensor so as to update the map information of a local region in the exploration region, and a second exploration process for moving the measurement range of the three-dimensional sensor to a position away from the local region in order to update the map information of a region different from the local region updated in the first exploration process.

### SUMMARY

Disclosed herein is a robot system. The robot system may include: a sensor configured to acquire three-dimensional data of an object disposed in a real space; a robot configured to change a position of the sensor; circuitry configured to: recognize, based on three-dimensional first data acquired by the sensor, an empty region in the real space where the object does not exist; control the robot so as to dispose the sensor in the empty region; and model the real space based on recognized empty regions including the empty region and a new empty region, the new empty region recognized based on three-dimensional second data newly acquired by the sensor from the empty region.

Additionally, a modeling method is disclosed herein. The modeling method may include: recognizing, based on three-dimensional first data of an object disposed in a real space acquired by a sensor, an empty region in the real space where the object does not exist; controlling a robot so as to dispose the sensor in the empty region; recognizing a new empty region based on three-dimensional second data newly acquired by the sensor disposed in the empty region; and modeling the real space based on recognized empty regions including the empty region and the new empty region.

Additionally, a non-transitory memory device is disclosed herein. The non-transitory memory device may have instructions stored thereon that, in response to execution by a processing device, cause the processing device to perform operations including: recognizing, based on three-dimensional first data of an object disposed in a real space acquired by a sensor, an empty region in the real space where the object does not exist; controlling a robot so as to dispose the sensor in the empty region; recognizing a new empty region based on three-dimensional second data newly acquired by the sensor disposed in the empty region; and modeling the real space based on recognized empty regions including the empty region and the new empty region.

### BRIEF DESCRIPTION OF THE DRAWINGS

FIG. 1 is a schematic diagram illustrating an example configuration of a robot system.

FIG. 2 is a diagram illustrating an example method for recognizing an empty region.

FIG. 3 is a schematic diagram illustrating an example modeling procedure.

FIG. 4 is a schematic diagram illustrating an example modeling procedure.

FIG. 5 is a schematic diagram illustrating an example modeling procedure.

FIG. 6 is a schematic diagram illustrating an example modeling procedure.

FIG. 7 is a schematic diagram illustrating an example modeling procedure.

FIG. 8 is a schematic diagram illustrating an example modeling procedure.

FIG. 9 is a block diagram illustrating an example hardware configuration of a controller.

FIG. 10 is a flowchart illustrating an example control procedure.

FIG. 11 is a flowchart illustrating an example modeling procedure.

FIG. 12 is a flowchart illustrating an example control procedure after modeling.

### DETAILED DESCRIPTION

In the following description, with reference to the drawings, the same reference numbers are assigned to the same components or to similar components having the same function, and overlapping description is omitted.

### Robot System

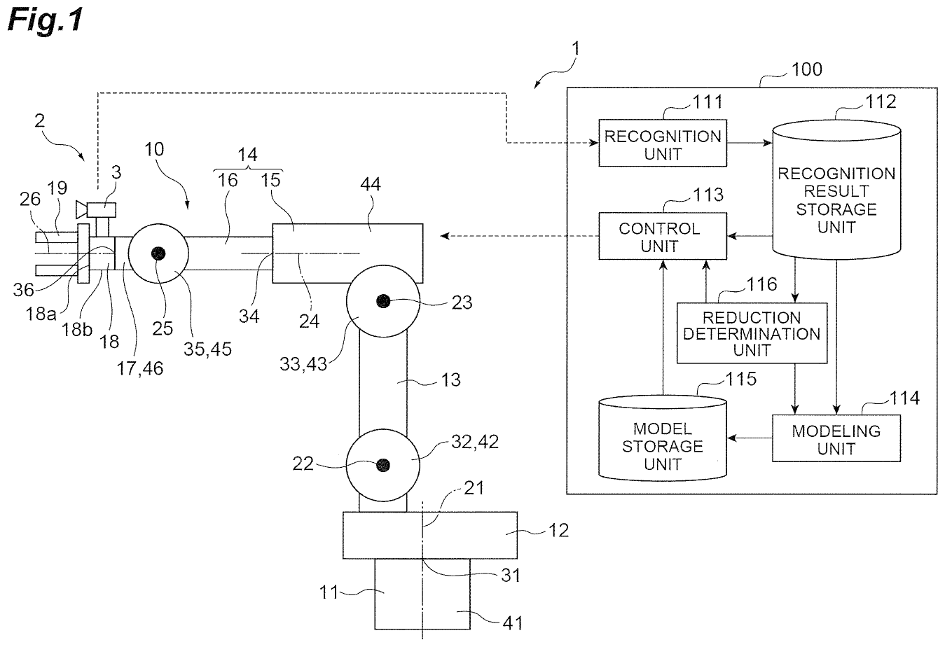

The robot system 1 illustrated in FIG. 1 is a system that operates a robot 2 to execute a predetermined task. As illustrated in FIG. 1, the robot system 1 includes a sensor 3 and a robot 2. The sensor 3 acquires three-dimensional data of an object disposed in a real space. The object has an entity occupying a part of the real space. Examples of the object include another robot provided around the robot 2, a machine tool provided around the robot 2, a workpiece as a task target of the robot 2, a rack for storing the workpiece, a rack for storing a tool used by the robot 2, a frame for holding another object in the real space, and the like.

The three-dimensional data of the object numerically represents, for example, the shape of the surface of the object. An example of the three-dimensional data is point cloud data representing the positions of a plurality of points on the surface in a coordinate system defined in the real space.

The sensor 3 is, for example, a time of flight (TOF) camera. The TOF camera includes a light source and an imaging element including a plurality of pixels. The light source emits light toward the object. Light reflected by the surface of the object enters a pixel corresponding to the reflection direction among the plurality of pixels of the imaging element. The TOF camera acquires distance information to the position where the light is reflected, for each of the plurality of pixels, based on the elapsed time from emission of the light to incidence on the imaging element.

The TOF camera is merely an example. The sensor 3 may be any sensor as long as it can acquire the three-dimensional data as defined above. For example, the sensor 3 may be a stereo camera. The sensor 3 may also be a laser scanning type three-dimensional shape sensor.

The robot 2 operates to execute a predetermined task. The robot 2 is configured to change the position and posture of the sensor 3, and the task includes changing the position of the sensor 3.

For example, the robot 2 includes an end part 18 to which the sensor 3 is fixed, an arm 10 connected to the end part 18 and configured to change a position of the end part 18, and one or more wrist axes configured to change the posture of the end part 18 with respect to the arm 10.

For example, the arm 10 is a serial-link-type robot arm. For example, the arm 10 is a vertically articulated robot arm and includes a base 11, a swivel part 12, a first arm 13, a second arm 14, a third arm 17, and drive axes 41, 42, 43, 44, 45, and 46.

The base 11 is fixed to a floor surface, a wall surface, a ceiling surface, or the like. The base 11 may also be fixed to a mobile body such as an automated guided vehicle. The swivel part 12 is provided on the base 11 so as to swivel about a vertical axis 21.

The first arm 13 is connected to the swivel part 12 so as to swing about an axis 22 intersecting (for example, orthogonal to) the axis 21, and extends in a direction away from the axis 21. The intersection includes being skew such as a three-dimensional intersection. The same applies hereinafter.

The second arm 14 is connected to the end of the first arm 13 so as to swing about an axis 23 parallel to the axis 22. The second arm 14 includes an arm base 15 and an arm end 16. The arm base 15 is connected to the end of the first arm 13 so as to swing about the axis 23 parallel to the axis 22, and extends in a direction away from the axis 23. The arm end 16 is connected to the end of the arm base 15 so as to swivel about an axis 24 along the arm base 15, and extends in a direction away from the end of the arm base 15. The third arm 17 is connected to the end of the arm end 16 so as to swing about an axis 25 intersecting the axis 24, and extends in a direction away from the axis 25.

The end part 18 is connected to the third arm 17 so as to swivel about an axis 26 along the third arm 17. Various tools for performing various tasks are attached to and detached from the end part 18. Examples of the tool include a hand for suction or gripping a workpiece, a welding torch for welding the workpiece, an electric driver for screwing the workpiece, and the like. For example, the end part 18 has a flat surface 18a (flange) intersecting (for example, orthogonal to) the axis 26, and the tool 19 is attached to the flat surface 18a.

Furthermore, the sensor 3 is fixed to the end part 18. For example, the end part 18 has an outer peripheral surface 18b surrounding the axis 26. The sensor 3 is fixed to the outer peripheral surface 18b so that, for example, the direction in which the flat surface 18a faces coincides with the sensing direction of the sensor 3.

The arm 10 described above includes a joint 31 as a connection between the base 11 and the swivel part 12, a joint 32 as a connection between the swivel part 12 and the first arm 13, a joint 33 as a connection between the first arm 13 and the arm base 15, a joint 34 as a connection between the arm base 15 and the arm end 16, a joint 35 as a connection between the arm end 16 and the third arm 17, and a joint 36 as a connection between the third arm 17 and the end part 18.

The drive axes 41, 42, 43, 44, 45, and 46 drive the joints 31, 32, 33, 34, 35, and 36, respectively. For example, the drive axis 41 drives the swivel part 12 to swivel about the axis 21 with respect to the base 11.

The drive axis 42 drives the first arm 13 to swing about the axis 22 with respect to the swivel part 12. The drive axis 43 drives the arm base 15 to swing about the axis 23 with respect to the first arm 13. The drive axis 44 drives the arm end 16 to swivel about the axis 24 with respect to the arm base 15. The drive axis 45 drives the third arm 17 to swing about the axis 25 with respect to the arm end 16. The drive axis 46 drives the end part 18 to swivel about the axis 26 with respect to the third arm 17.

Each of the drive axes 41, 42, 43, 44, 45, and 46 includes an electric servomotor, a sensor (for example, an encoder) for detecting the rotation angle of the servomotor, and a speed reducer. By driving the joints 31, 32, 33, 34, 35, and 36 with the drive axes 41, 42, 43, 44, 45, and 46, the position and posture of the end part 18 can be freely changed.

The position and posture of the sensor 3 connected to the end part 18 are also changed in accordance with the change in the position and posture of the end part 18.

The drive axes 44, 45, and 46 are the above-described one or more wrist axes for changing the posture of the end part 18 with respect to the arm 10. The drive axes 41, 42, and 43 are arm drive axes for changing the positions of one or more of the wrist axes.

The configuration of the robot 2 described above is merely an example. The robot 2 may be configured in any manner as long as the robot 2 can change the position of the sensor 3. For example, the robot 2 may be a redundant robot having seven or more drive axes. The robot 2 may be a so-called SCARA type robot.

The controller 100 operates, based on a predetermined motion program, the robot 2 to execute a predetermined task. The controller 100 may generate at least a part of the motion program so as to execute a predetermined task based on a model of the real space, and may operate the robot 2 based on the generated motion program. If there is a discrepancy between the real space and the model of the real space, a reliable motion program may not be generated. Therefore, the controller 100 is configured to model the real space based on the three-dimensional data acquired by the sensor 3.

A method for modeling the real space based on the three-dimensional data is described in Japanese Unexamined Patent Publication No. 2022-070079. Japanese Unexamined Patent Publication No. 2022-070079 describes controlling a robot so as to move the measurement range of a three-dimensional sensor, and updating map information indicating the exploration status of each point in an exploration region based on the measurement result by the three-dimensional sensor. This method moves the three-dimensional sensor around the periphery of the exploration region on the premise that there is nothing to hinder the motion of the robot around the periphery of the exploration region. Therefore, the method may not be applicable to situations where the state around the periphery of the exploration region is unknown. In addition, the method may require a significant amount of effort to predefine the exploration region.

Accordingly, the controller 100 is configured to execute: recognizing, based on three-dimensional first data acquired by the sensor 3, an empty region in the real space where the object does not exist; controlling the robot 2 so as to dispose the sensor 3 in the empty region; and modeling the real space based on recognized empty regions including the empty region and a new empty region recognized based on three-dimensional second data newly acquired by the sensor 3 from the empty region.

Thus, the real space is modeled based on the empty region recognized based on the three-dimensional data (first data) and the empty region newly recognized based on the three-dimensional data (second data) newly acquired by disposing the sensor in the recognized empty region. According to this method of moving the sensor into an empty region to recognize a new empty region, even if the acquisition of the three-dimensional data is started in a state where the state of the real space is completely unknown, the empty region can be recognized based on the three-dimensional data (first data) and the three-dimensional data (second data) can be acquired while moving the sensor by using the recognized empty region as a destination for moving the sensor. Therefore, the real space can be modeled with versatility and convenience.

Further, according to the method of disposing the sensor in the recognized empty region, three-dimensional data of a region that would be a blind spot from outside the empty region can be readily acquired. Therefore, the real space can be modeled with efficiency.

For example, the controller 100 includes a recognition unit 111, a recognition result storage unit 112, a control unit 113, a modeling unit 114, and a model storage unit 115 as functional constituents (hereinafter referred to as “functional blocks”). The recognition unit 111 recognizes, based on the three-dimensional data (first data) acquired by the sensor 3, the empty region in the real space where the object does not exist. For example, the recognition unit 111 recognizes, based on the three-dimensional data (first data), that a region between the sensor 3 and the object is the empty region. For example, the recognition unit 111 recognizes that the region between the surface of the object represented by the point cloud data or the like and the sensor 3 is the empty region.

As an example, the recognition unit 111 recognizes a group of voxels belonging to the empty region in a data format representing the real space as a set of a plurality of voxels. For example, the recognition unit 111 classifies each of the plurality of voxels as an “empty cell” or an “unconfirmed cell.” The “empty cell” is a cell not occupied by the object. The “unconfirmed cell” is a cell for which it is unknown whether it is occupied by the object.

For example, the recognition unit 111 classifies, among the plurality of voxels, each of one or more voxels located between the surface of the object and the sensor 3 as an “empty cell,” and classifies other cells as “unconfirmed cells.” The recognition unit 111 recognizes the empty region as a set of one or more voxels classified as “empty cells.”

The recognition unit 111 may further classify the “unconfirmed cells” into “hidden cells” and “unobserved cells.” The “hidden cell” is a cell that was not observed because it was hidden by the object. The “unobserved cell” is a cell that was not included in the sensing range of the sensor 3. For example, the recognition unit 111 classifies, among the plurality of voxels, each of one or more voxels included in the sensing range of the sensor 3 and located deeper than the surface of the object as a “hidden cell,” and classifies each of one or more voxels not classified as either “empty cell” or “hidden cell” as an “unobserved cell.”

The recognition unit 111 may recognize, when the three-dimensional data of the object cannot be acquired by the sensor 3, a region from the sensor 3 to a predetermined detectable depth as the empty region. The “depth” is the distance from the sensor 3. For example, when the sensor 3 is the above-described TOF camera, if there is no object in the sensing range, light does not enter the imaging element, and thus the three-dimensional data of the object is not acquired. Even if there is an object, if the depth from the sensor 3 to the object is large, the three-dimensional data of the object may not be acquired because light does not enter the imaging element with sufficient intensity. The above-described detectable depth is a depth at which the three-dimensional data of the object can be acquired. If the depth from the sensor 3 to the object is less than or equal to the detectable depth, the three-dimensional data of the object can be acquired.

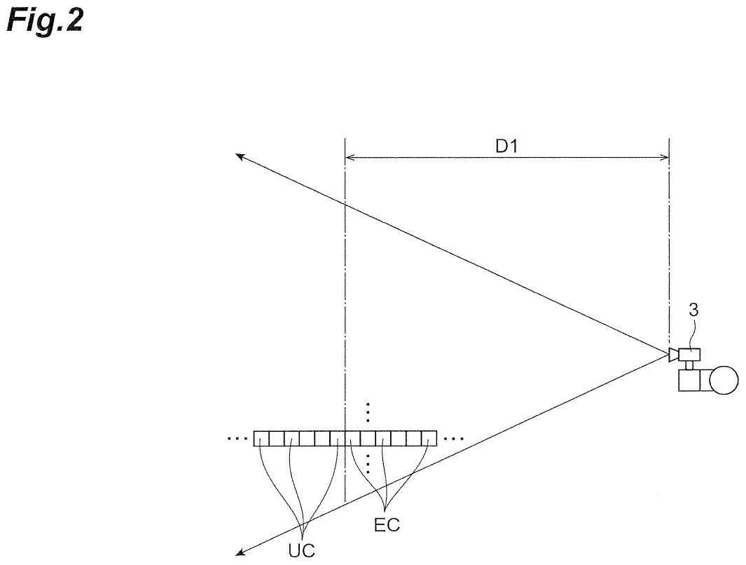

As illustrated in FIG. 2, the recognition unit 111 classifies one or more voxels located between the sensor 3 and the detectable depth DI in the sensing range of the sensor 3 as empty cells EC and adds the voxels to the empty region, and classifies one or more voxels located in a region deeper than the detectable depth DI as unconfirmed cells UC. The recognition unit 111 may classify the unconfirmed cells UC as “unobserved cells.” Even when the sensor does not acquire the three-dimensional data of the object, by recognizing that a part of the region toward which the sensor is directed is the empty region, the real space can be modeled more efficiently.

Returning to FIG. 1, the recognition result storage unit 112 stores

the recognition result by the recognition unit 111. For example, the recognition result storage unit 112 stores the coordinates of each of the plurality of voxels in association with the classification result obtained by the recognition unit 111.

The control unit 113 controls the robot 2. For example, the control unit 113 operates the robot 2 based on a motion program. The motion program is a program for causing the robot 2 to execute a motion.

As an example, the motion program includes a plurality of motion commands arranged in chronological order. Each of the plurality of motion commands includes a target posture of the robot 2 and a target displacement speed to the target posture. The target posture of the robot 2 may be represented by the target position and target posture of the end part 18. The target displacement speed of the robot 2 is represented by the target displacement speed of the end part 18. The target posture of the robot 2 may be represented by the target angles of the drive axes 41, 42, 43, 44, 45, and 46. The target displacement speed of the robot 2 is represented by the respective target rotational speeds of the drive axes 41, 42, 43, 44, 45, and 46.

For example, the control unit 113 causes the robot 2 to execute a motion by repeatedly performing a control cycle including the following processes:
Process 1) Sequentially select motion commands.
Process 2) Calculate, based on information representing the current posture of the robot 2 and the motion command, the cycle target angles of the drive axes 41, 42, 43, 44, 45, and 46 in the control cycle.

Process 3) Operate each of the drive axes 41, 42, 43, 44, 45, and 46 to the cycle target angle. The cycle target angle is the target angle for each control cycle.

When the target posture of the robot 2 in the motion command is represented by the target position and target posture of the end part 18, the recognition result storage unit 112 calculates, in process 2, the cycle target position and cycle target posture of the end part 18 in the control cycle by interpolating between the current position and posture of the end part 18 and the target position and posture of the end part 18. The cycle target position and cycle target posture are the target position and target posture for each control cycle. The recognition result storage unit 112 performs inverse kinematics calculation for the cycle target position and cycle target posture of the end part 18 to calculate the cycle target angles of the drive axes 41, 42, 43, 44, 45, and 46.

When the target posture of the robot 2 in the motion command is represented by the target angles of the drive axes 41, 42, 43, 44, 45, and 46, the recognition result storage unit 112 calculates, in process 2, the cycle target angles of the drive axes 41, 42, 43, 44, 45, and 46 in the control cycle by interpolating between the current angles of the drive axes 41, 42, 43, 44, 45, and 46 and the target angles of the drive axes 41, 42, 43, 44, 45, and 46.

In process 3, the recognition result storage unit 112 calculates a

torque command for rotating each of the drive axes 41, 42, 43, 44, 45, and 46 to the cycle target angle, and supplies current for generating torque corresponding to the torque command.

When modeling the real space, the control unit 113 controls the robot 2 so as to execute a motion for disposing the sensor 3 in the empty region recognized by the recognition unit 111. Hereinafter, the motion for disposing the sensor 3 in the empty region is referred to as “entry motion.”

For example, the control unit 113 calculates a movement path of the end part 18 for moving the sensor 3 from the current position to the empty region based on the recognition result of the empty region by the recognition unit 111, and generates a motion program for the entry motion so as to move the end part 18 along the calculated movement path. The control unit 113 causes the robot 2 to execute the entry motion by repeatedly performing the above control cycle based on the generated motion program. After the control unit 113 disposes the sensor 3 in the empty region, the recognition unit 111 recognizes a new empty region based on the three-dimensional data (second data) newly acquired by the sensor 3 from the empty region.

The modeling unit 114 models the real space based on the empty region in which the sensor 3 is disposed and the above-described new empty region. For example, the modeling unit models the real space by treating a region surrounded by empty regions as a region occupied by the object. For example, the modeling unit generates, as a modeling result, model data representing the boundary between the region occupied by the object and other regions as a point cloud, a polygon, or the like, based on the recognition result stored in the recognition result storage unit 112, and stores the model data in the model storage unit 115.

The modeling unit 114 may model the real space based on the three-dimensional model data of the real space prepared in advance and the above-described region surrounded by the empty region. For example, the modeling unit 114 may correct the position and posture of the object in the three-dimensional model data of the real space prepared in advance so as to match the region occupied by the object, and generate the corrected three-dimensional model data as a modeling result.

The control unit 113 may control the robot 2 to execute a scanning motion for changing the posture of the sensor 3 within the empty region, and the recognition unit 111 may recognize a new empty region based on the three-dimensional data (second data) acquired by the sensor in a plurality of postures within the empty region. A new empty region can be recognized over a wide range around the empty region. Therefore, the real space can be modeled more efficiently. For example, the control unit 113 stores a relative program for relatively changing the posture of the sensor 3 according to a predetermined motion pattern with respect to the position and posture of the sensor 3 at the start of the scanning motion, and generates a motion program for the scanning motion based on the position and posture of the sensor 3 disposed in the empty region and the motion pattern. The control unit 113 causes the robot 2 to execute the scanning motion by repeatedly performing the above control cycle based on the generated motion program.

The control unit 113 may cause the robot 2 to execute a scanning

motion for operating one or more of the wrist axes so as to change the posture of the sensor 3 within the empty region while keeping the arm 10 at an identical posture. The state in which the arm 10 is fixed means a state in which drive axes other than one or more of the wrist axes are fixed. For example, the state in which the arm 10 is fixed means a state in which the drive axes 41, 42, and 43 other than the drive axes 44, 45, and 46, which are one or more of the wrist axes, are fixed.

As an example, the control unit 113 stores, as the above-described relative program, a motion program represented by motion angles of the drive axes 44, 45, and 46. After operating the robot 2 so as to dispose the sensor 3 in the empty region, the control unit 113 operates the drive axes 44, 45, and 46 according to the motion pattern based on the relative program while the drive axes 41, 42, and 43 are fixed.

By operating one or more of the wrist axes while the arm 10 is fixed, the posture of the sensor 3 can be changed in various ways within the limited empty region. Therefore, the real space can be modeled more efficiently.

The control unit 113 may operate one or more of the wrist axes so as to change the posture of the sensor 3 disposed at the initial position before the empty region is recognized by the recognition unit 111, and the recognition unit 111 may recognize the empty region based on the three-dimensional data (first data) acquired by the sensor 3 in a plurality of postures at the initial position. the empty region can be recognized over a wide range around the initial position. Therefore, the real space can be modeled more efficiently.

The initial position may be taught by an operation performed by

an operator. The operation may be an operation for moving the robot 2 to the initial position by an operation terminal such as a teaching pendant, or a direct operation for guiding the robot 2 to the initial position by applying an external force to the robot 2 itself. When the sensor 3 is disposed at the initial position, the control unit 113 causes the robot 2 to execute the above-described scanning motion.

The recognition unit 111 may recognize the empty region further based on three-dimensional data (first data) acquired by an external sensor provided in the real space separately from the sensor 3. By additionally employing the external sensor, the real space can be modeled more efficiently.

The control unit 113 may specify, within the empty region, a position of the sensor 3 where the sensor 3 does not move out of the empty region even when one or more of the wrist axes are operated in accordance with a predetermined motion pattern, operate the arm 10 so as to dispose the sensor 3 at the specified position, and operate one or more of the wrist axes in accordance with the motion pattern so as to change the posture of the sensor 3 within the empty region.

The posture of the sensor can be readily changed depending on the motion pattern. Therefore, the real space can be modeled more efficiently.

For example, the control unit 113 calculates, based on the position and posture of the sensor 3 at the start of the motion according to the motion pattern, a region occupied by the sensor 3 when the drive axes 44, 45, and 46 are operated. Hereinafter, this region is referred to as the “sensor occupation region.” The position and posture of the sensor 3 at the start of the motion according to the motion pattern is referred to as a scan start position. The control unit 113 specifies the scan start position of the sensor 3 within the empty region so that the sensor occupation region is contained within the empty region, and controls the robot 2 so as to dispose the sensor 3 at the specified scan start position.

Instead of disposing the sensor 3 so that the sensor occupation region is contained within the empty region, the control unit 113 may generate a motion pattern of one or more of the wrist axes so as to change the posture of the sensor 3 disposed in the empty region, without causing the sensor 3 disposed in the empty region to move out of the empty region, and operate one or more of the wrist axes in accordance with the generated motion pattern so as to change the posture of the sensor 3 within the empty region. Even a small empty region can be utilized for disposing the sensor, and the real space can be modeled more efficiently.

For example, the control unit 113 deletes a part of the motion pattern so that the sensor 3 is not displaced to a portion of the sensor occupation region located outside the empty region, and generates a motion pattern that does not cause the sensor 3 to move out of the empty region.

The controller 100 may be configured to repeat placing the sensor in the empty region by the control unit 113 and recognizing the new empty region by the recognition unit 111, and to model the real space by the modeling unit 114 based on the recognized empty region.

The modeling unit 114 may model the real space based on all the recognized empty regions, or may model the real space based on a part of the recognized empty regions.

For example, the controller 100 further includes a reduction determination unit 116. The reduction determination unit 116 determines whether a remaining region of the real space has been reduced until a predetermined condition is satisfied, the remaining region being a region where it is not specified whether the region is occupied by an object. For example, the reduction determination unit 116 recognizes the remaining region as a set of one or more voxels classified into the above-described unconfirmed cells.

Examples of the predetermined condition include “the volume of the remaining region is less than or equal to a predetermined volume threshold.” The reduction determination unit 116 calculates the volume of the remaining region based on the volume of one or more voxels classified as unconfirmed cells, and checks whether the calculated volume is less than or equal to the volume threshold. The predetermined condition may be “the ratio of the remaining region in the real space is less than or equal to a predetermined ratio threshold.”

The reduction determination unit 116 may check whether the remaining region has been reduced until the predetermined condition is satisfied not for the entire real space but for a part of the real space. For example, the reduction determination unit 116 may check whether the remaining region has been reduced until the predetermined condition is satisfied for a planned motion space in which the robot 2 is scheduled to move in the real space.

The controller 100 may further be configured to: determine, after the new empty region has been recognized, whether a remaining region of the real space is reduced until a predetermined condition is satisfied, the remaining region being a region where it is not specified whether the region is occupied by an object; control, in response to determining that the remaining region is not reduced until the predetermined condition is satisfied, the robot 2 so as to dispose the sensor 3 in the new empty region; recognize additional new empty region based on additional second data newly acquired by the sensor 3 from the new empty region; redetermine, after the additional new empty region has been recognized, whether the remaining region of the real space is reduced until the predetermined condition is satisfied; and model, in response to determining that the remaining region is reduced until the predetermined condition is satisfied, the real space based on the recognized empty regions further including the additional new empty region. For example, the controller 100 repeats, until the reduction determination unit 116 determines that the remaining region has been reduced so that the predetermined condition is satisfied, placing the sensor in the empty region by the control unit 113 and recognizing the new empty region by the recognition unit 111, and models the real space by the modeling unit 114 based on the recognized empty region. By repeating, the remaining region can be sufficiently reduced.

After the remaining region has been reduced until the predetermined condition is satisfied, the control unit 113 may control the robot 2 so as to direct the sensor 3 to the remaining region, and the recognition unit 111 may recognize a new empty region (remaining empty region) in the remaining region based on the three-dimensional data (third data) acquired by the sensor 3 directed to the remaining region. By sufficiently reducing the remaining region and acquiring three-dimensional data (third data) focusing on the remaining region, the remaining region can be reduced more efficiently. The model unit 114 may model the real space based on the recognized empty regions further including the remaining empty region.

The control unit 113 may control the robot 2 so as to direct the

sensor 3 toward the remaining region and to direct the sensor 3 toward the back side of the recognized surface of the object. The remaining region can be reduced more efficiently.

The control unit 113 may control the robot 2 so as to direct the sensor 3 toward the remaining region from a plurality of locations, and the recognition unit 111 may recognize the remaining empty region in the remaining region based on a plurality of sets of three-dimensional data (third data) acquired by the sensor 3 directed toward the remaining region from the plurality of locations. Based on a plurality of additional three-dimensional data (third data) acquired from a plurality of locations for the identical remaining region, the remaining region can be reduced more efficiently.

The control unit 113 may control the robot 2 to execute a task in cooperation with the object disposed in the real space based on a modeling result of the real space by the modeling unit 114. For example, when the object is a machine tool, the control unit 113 generates a motion program for transporting a workpiece into the machine tool based on a modeling result of the real space by the modeling unit 114, and controls the robot 2 based on the generated motion program.

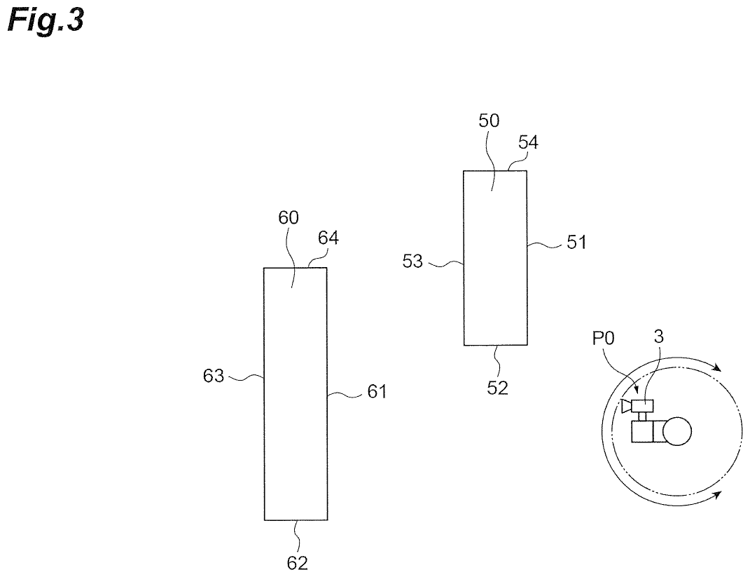

With reference to FIGS. 3 to 8, an example of a modeling procedure executed by the controller 100 will be described. In the example illustrated in FIG. 3, objects 50 and 60 are disposed in the real space. The object 50 has surfaces 51, 52, 53, and 54, and the object 60 has surfaces 61, 62, 63, and 64.

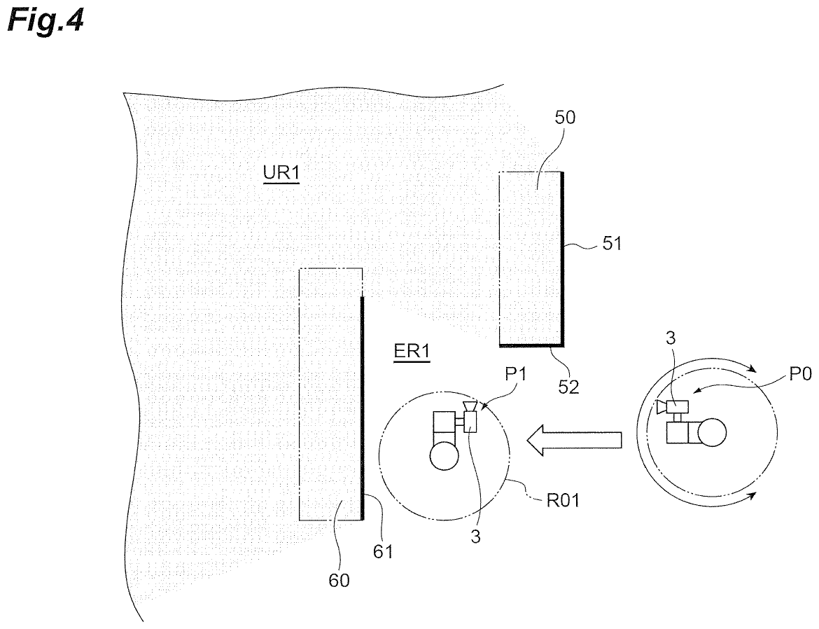

First, the control unit 113 operates one or more of the wrist axes according to the above-described motion pattern so as to change the posture of the sensor 3 disposed at the initial position PO. The recognition unit 111 recognizes, based on the three-dimensional data (first data) acquired by the sensor 3 in a plurality of postures at the initial position P0, the surfaces 51, 52, and 61 and the empty region ERI as illustrated in FIG. 4. In FIG. 4, the remaining region URI not recognized as the empty region ERI is indicated by a dot pattern.

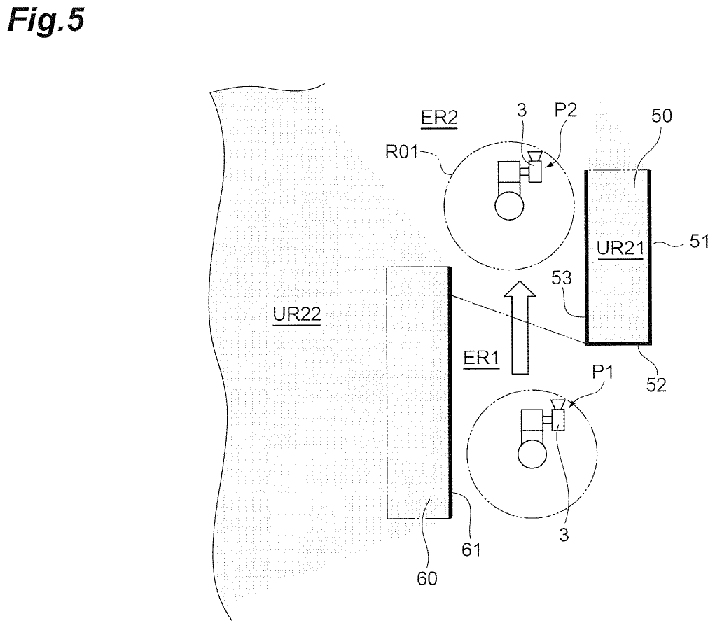

Next, the control unit 113 specifies a scan start position PI of the sensor 3 within the empty region ERI so that a sensor occupation region R01 occupied by the sensor 3 when one or more of the wrist axes are operated according to the motion pattern is contained within the empty region ER1, and controls the robot 2 so as to dispose the sensor 3 at the specified scan start position P1. Next, the control unit 113 operates one or more of the wrist axes according to the motion pattern so as to change the posture of the sensor 3. The recognition unit 111 recognizes, based on the three-dimensional data (second data) acquired by the sensor 3 in a plurality of postures, the surface 53 and a new empty region ER2 as illustrated in FIG. 5.

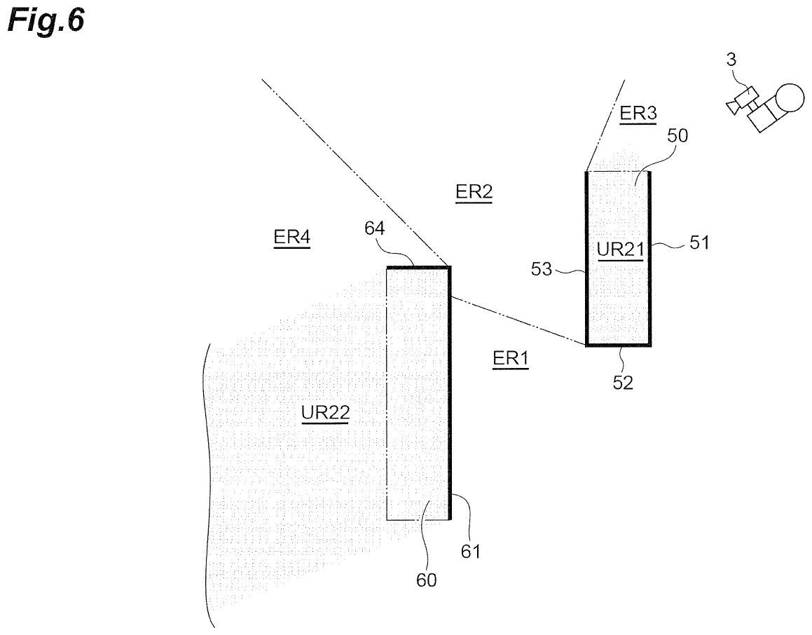

Next, the control unit 113 specifies a scan start position P2 of the sensor 3 within the empty region ER2 so that the sensor occupation region R01 is contained within the empty region ER2, and controls the robot 2 so as to dispose the sensor 3 at the specified scan start position P2. Next, the control unit 113 operates one or more of the wrist axes according to the motion pattern so as to change the posture of the sensor 3. The recognition unit 111 recognizes, based on the three-dimensional data (second data) acquired by the sensor 3 in a plurality of postures, the surface 64 and new empty regions ER3 and ER4 as illustrated in FIG. 6.

As described above, when the reduction determination unit 116 determines that the remaining region has been reduced until the predetermined condition is satisfied, the control unit 113 controls the robot 2 so as to direct the sensor 3 toward the remaining region, and the recognition unit 111 recognizes a new empty region (remaining empty region) in the remaining region based on the three-dimensional data (third data) acquired by the sensor 3 directed toward the remaining region.

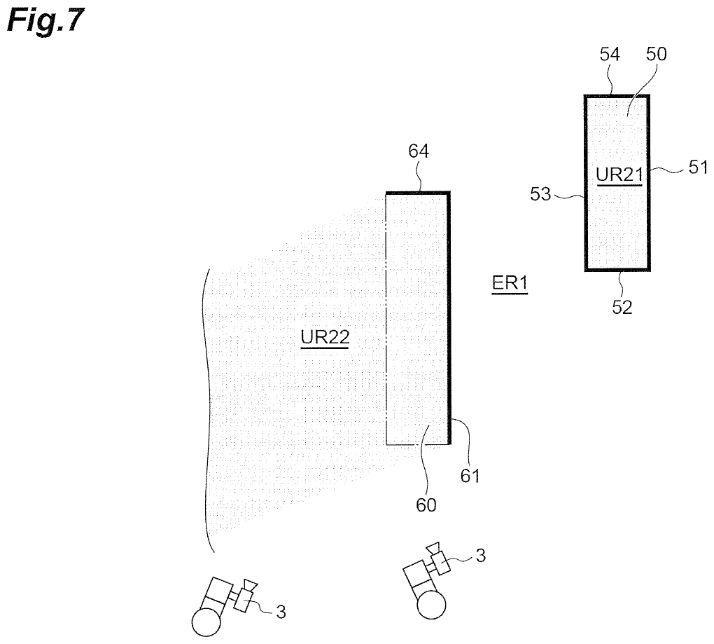

For example, as illustrated in FIG. 6, the control unit 113 controls the robot 2 so as to direct the sensor 3 toward the remaining region UR21 and to direct the sensor 3 toward the back side of the surface 53 for which the three-dimensional data has already been acquired. When acquiring data, the accuracy of alignment can be improved by gradually directing the sensor toward the back side while reacquiring the data of the surface 51 for which the three-dimensional data has already been acquired. The recognition unit 111 recognizes, based on the three-dimensional data (third data) acquired by the sensor 3 directed toward the remaining region UR21, a new empty region in the remaining region UR21 and the surface 54 as illustrated in FIG. 7.

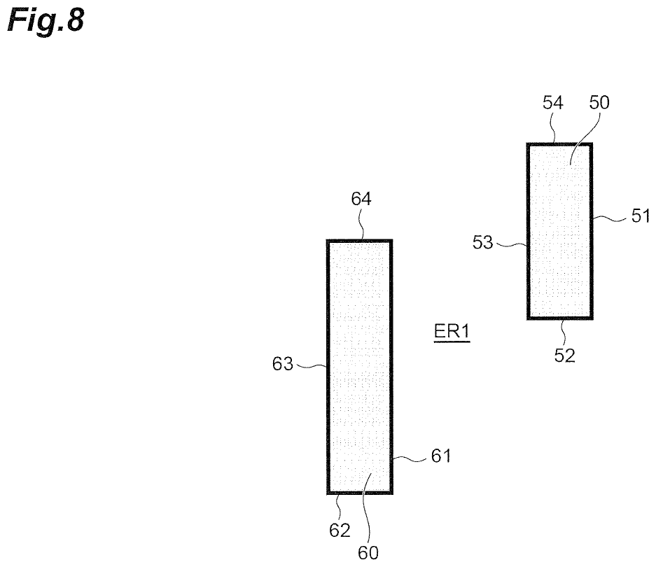

Next, the control unit 113 controls the robot 2 so as to direct the sensor 3 toward the remaining region UR22 from a plurality of locations. The recognition unit 111 recognizes, based on a plurality of sets of three-dimensional data acquired by the sensor 3 directed toward the remaining region from a plurality of locations, the new empty region (remaining empty region) in the remaining region UR22 and the surfaces 62 and 63 as illustrated in FIG. 8. The modeling unit 114 models the real space by treating the remaining regions UR21 and UR22 surrounded by the recognized empty regions as regions occupied by the objects 50 and 60.

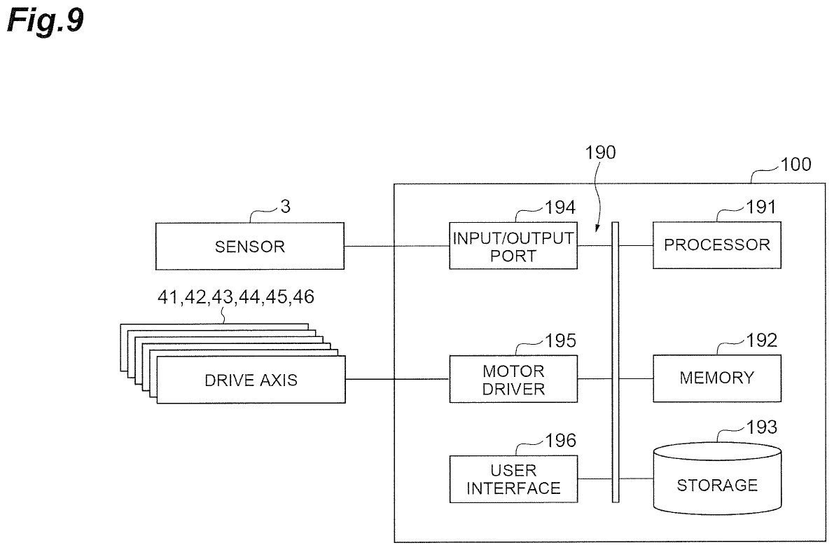

FIG. 9 is a block diagram illustrating an example hardware configuration of the controller. As illustrated in FIG. 9, the controller 100 includes circuitry 190. The circuitry 190 includes a processor 191, a memory 192, a storage 193, an input/output port 194, a motor driver 195, and a user interface 196. The storage 193 includes one or more non-volatile storage devices. Examples of the non-volatile storage device include a hard disk drive and a flash memory. The storage device may be a device for storing information on a portable storage medium. The storage 193 stores a program for causing the controller 100 to execute: recognizing, based on the three-dimensional data (first data) acquired by the sensor 3, an empty region in the real space where the object does not exist; controlling the robot 2 so as to dispose the sensor 3 in the empty region; and modeling the real space based on the empty region in which the sensor 3 is disposed and a new empty region recognized based on the three-dimensional data (second data) newly acquired by the sensor 3 from the empty region. For example, the storage 193 stores a program for causing the controller 100 to configure the above-described plurality of functional blocks.

The memory 192 includes one or more volatile storage devices. Examples of the volatile storage device include random-access memory. The memory 192 temporarily stores a program loaded from the storage 193. The processor 191 includes one or more arithmetic elements. Examples of the arithmetic element include a central processing unit (CPU) and a graphics processing unit (GPU). The processor 191 configures the above-described multiple functional blocks in the controller 100 by executing the program loaded into the memory 192.

The input/output port 194 exchanges information with the sensor 3 and the like in response to a request from the processor 191. The motor driver 195 operates the drive axes 41, 42, 43, 44, 45, and 46 in response to a request from the processor 191. The user interface 196 includes an input device and a display device, acquires input to the input device in response to a request from the processor 191, and displays characters, images, and the like on the display device in response to a request from the processor 191. Examples of the display device include a liquid crystal display and an organic electro-luminescence (EL) display. Examples of the input device include a keyboard, a mouse, a touchpad, and the like.

The input device may be integrated with the display device as a so-called touch panel.

The circuitry 190 may not be limited to a single circuit and may be composed of a plurality of circuits capable of communicating with each other by wire or wirelessly.

### Control Procedure

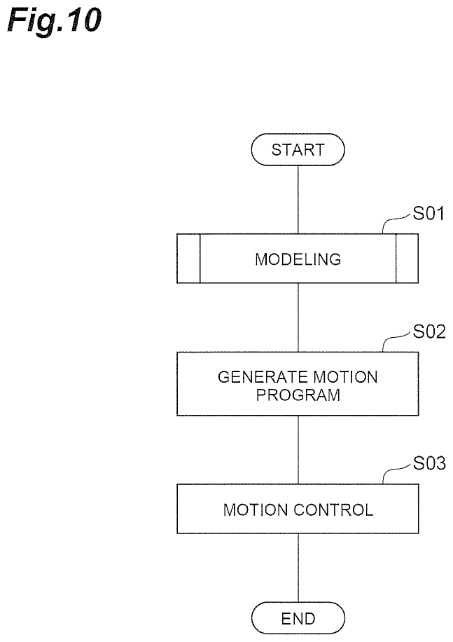

Next, an example control procedure for the robot 2 including a modeling procedure as one example of the modeling method will be described. As illustrated in FIG. 10, the controller 100 executes operations S01, S02, and S03. In operation S01, the controller 100 executes: recognizing, by the recognition unit 111, the empty region; controlling, by the recognition result storage unit 112, the robot to dispose the sensor in the empty region; recognizing, by the recognition unit 111, a new empty region based on the three-dimensional data (second data) newly acquired by the sensor disposed in the empty region; and modeling, by the modeling unit 114, the real space based on the empty region in which the sensor is disposed and the new empty region. The details of operation S01 will be described later.

In operation S02, the control unit 113 generates, based on a

modeling result of the real space obtained by the modeling unit 114, a motion program for causing the robot 2 to execute a task in cooperation with the object disposed in the real space.

In operation S03, the control unit 113 controls the robot 2 to execute a task in cooperation with the object disposed in the real space based on the generated motion program.

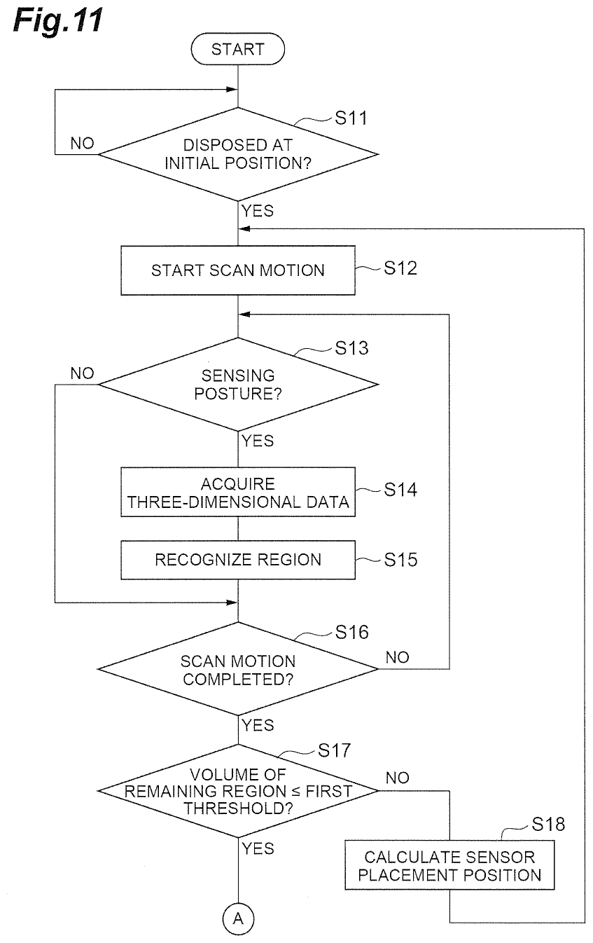

FIG. 11 is a flowchart illustrating the modeling procedure in operation S01. As illustrated in FIG. 11, the controller 100 first executes operations S11, S12, and S13. In operation S11, the control unit 113 waits for the sensor 3 to be disposed at the initial position by a teaching operation of the operator. In operation S12, the control unit 113 controls the robot 2 to start the above-described scanning motion. In operation S13, the recognition unit 111 checks whether the robot 2 has reached any of a plurality of sensing postures in the scanning motion.

If it is determined in operation S13 that the robot 2 has reached any of the plurality of sensing postures, the controller 100 executes operations S14 and S15. In operation S14, the recognition unit 111 acquires three-dimensional data (first data) from the sensor 3. In operation S15, the recognition unit 111 recognizes the empty region based on the three-dimensional data. For example, the recognition unit 111 classifies, among the plurality of voxels, one or more voxels within the sensing range of the sensor 3 as the above-described empty cells or unconfirmed cells, and recognizes a set of one or more voxels classified as empty cells as the empty region.

Next, the controller 100 executes operation S16. If it is determined in operation S13 that the robot 2 has not reached any of the plurality of sensing postures, the controller 100 executes operation S16 without executing operations S14 and S15. In operation S16, the control unit 113 checks whether the scanning motion has been completed.

If it is determined in operation S16 that the scanning motion has not been completed, the controller 100 returns the process to operation S13. Thereafter, until the scanning motion is completed, the posture change of the sensor 3, the acquisition of the three-dimensional data (first data), and the recognition of the empty region are repeated.

If it is determined in operation S16 that the scanning motion has been completed, the controller 100 executes operation S17. In operation S17, the reduction determination unit 116 checks whether the remaining region has been reduced until the predetermined condition is satisfied. For example, the reduction determination unit 116 checks whether the volume of the remaining region is less than or equal to a predetermined first threshold.

If it is determined in operation S17 that the volume of the

remaining region is greater than the first threshold, the controller 100 executes operation S18. In operation S18, the control unit 113 controls the robot 2 to dispose the sensor 3 in the empty region. Thereafter, the controller 100 returns to operation S12. Thereafter, until the volume of the remaining region becomes less than or equal to the first threshold, placing the sensor in the empty region by the control unit 113 and recognizing the new empty region by the recognition unit 111 are repeated.

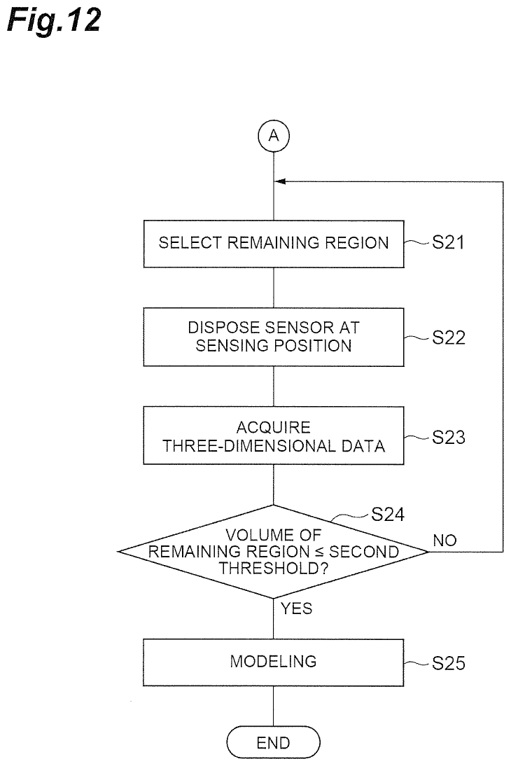

If it is determined in operation S17 that the volume of the remaining region is less than or equal to the first threshold, the controller 100 executes operations S21, S22, S23, and S24 as illustrated in FIG. 12. In operation S21, the control unit 113 selects one of one or more remaining regions.

In operation S22, the control unit 113 controls the robot 2 so as to dispose the sensor 3 at a sensing position for the selected remaining region. The sensing position for the remaining region is a position and posture at which the sensor 3 should be disposed for sensing the remaining region. For example, the control unit 113 controls the robot 2 so as to dispose the sensor 3 at a sensing position facing the remaining region and facing the back side of the recognized surface of the object. In operation S23, the recognition unit 111 recognizes a new empty region (remaining empty region) in the remaining region based on the three-dimensional data (third data). In operation S24, the reduction determination unit 116 checks whether the volume of the remaining region is less than or equal to a predetermined second threshold. The second threshold is smaller than the first threshold.

If it is determined in operation S24 that the volume of the remaining region is greater than the second threshold, the controller 100 returns the process to operation S22. Thereafter, until the volume of the remaining region becomes smaller than the second threshold, selecting the remaining region and recognizing a new empty region in the remaining region by directing the sensor 3 toward the selected remaining region are repeated.

If it is determined in operation S24 that the volume of the remaining region is less than or equal to the second threshold, the controller 100 executes operation S25. In operation S25, the modeling unit 114 models the real space based on the recognized empty region. The modeling procedure is thus completed.

### Conclusion

The above-described disclosure includes the following configurations.
(1) A robot system 1 comprising: a sensor 3 configured to acquire three-dimensional data of an object disposed in a real space; a robot 2 configured to change a position of the sensor 3; a recognition unit 111 configured to recognize, based on the three-dimensional data acquired by the sensor 3, an empty region in the real space where the object does not exist; a control unit 113 configured to control the robot 2 so as to dispose the sensor 3 in the empty region; and a modeling unit 114 configured to model the real space based on the empty region in which the sensor 3 is disposed and a new empty region recognized by the recognition unit 111 based on the three-dimensional data newly acquired by the sensor 3 from the empty region.

According to the robot system 1, the real space is modeled based on the empty region recognized based on the three-dimensional data and the new empty region recognized based on the three-dimensional data newly acquired by disposing the sensor 3 in the recognized empty region. According to this method, three-dimensional data of a region that would be a blind spot from outside the empty region can be readily acquired by moving the sensor 3 into the empty region and recognizing a new empty region. Therefore, various real spaces can be readily modeled.
(2) The robot system 1 according to (1), wherein the control unit 113 is configured to change a posture of the sensor 3 within the empty region by the robot 2, and wherein the recognition unit 111 is configured to recognize the new empty region based on the three-dimensional data acquired by the sensor 3 in a plurality of postures within the empty region.

A new empty region can be recognized over a wide range around the empty region. Therefore, the real space can be modeled more efficiently.

(3) The robot system 1 according to (2), wherein the robot 2 comprises: an end part to which the sensor 3 is fixed; an arm 10 connected to the end part and configured to change a position of the end part; and one or more wrist axes configured to change the posture of the end part with respect to the arm 10, and wherein the control unit 113 is configured to operate the one or more wrist axes so as to change the posture of the sensor 3 within the empty region while the arm 10 is fixed. By operating one or more of the wrist axes while the arm 10 is fixed, the posture of the sensor 3 can be changed in various ways within the limited empty region. Therefore, the real space can be modeled more efficiently.
(4) The robot system 1 according to (3), wherein the control unit

113 is configured to operate the one or more wrist axes so as to change the posture of the sensor 3 disposed at the initial position before the empty region is recognized by the recognition unit 111, and wherein the recognition unit 111 is configured to recognize the empty region based on the three-dimensional data acquired by the sensor 3 in a plurality of postures at the initial position.

The empty region can be recognized over a wide range around the initial position. Therefore, the real space can be modeled more efficiently.
(5) The robot system 1 according to (3) or (4), wherein the control unit 113 is configured to: specify, within the empty region, a position where the sensor 3 does not move out of the empty region even when the one or more wrist axes are operated in accordance with a predetermined motion pattern; operate the arm 10 so as to dispose the sensor 3 at the specified position; and operate the one or more wrist axes in accordance with the motion pattern so as to change the posture of the sensor 3 within the empty region.

The posture of the sensor 3 can be readily changed by the predetermined motion pattern. Therefore, the real space can be modeled more efficiently.
(6) The robot system 1 according to (3) or (4), wherein the control unit 113 is configured to: generate a motion pattern of the one or more wrist axes so as to change the posture of the sensor 3 without causing the sensor 3 disposed in the empty region to move out of the empty region; and operate the one or more wrist axes in accordance with the generated motion pattern so as to change the posture of the sensor 3 within the empty region.

Even a small empty region can be utilized for disposing the sensor 3, and the real space can be modeled more efficiently.
(7) The robot system 1 according to any one of (1) to (6), further comprising a reduction determination unit 116 configured to determine whether a remaining region of the real space is reduced until a predetermined condition is satisfied, the remaining region being a region where it is not specified whether the region is occupied by an object, wherein the robot system 1 is configured to, until the reduction determination unit 116 determines that the remaining region has been reduced so that the predetermined condition is satisfied, repeat: disposing, with the control unit 113, the sensor 3 in the empty region, and recognizing, with the recognition unit 111, the new empty region, and the robot system 1 is configured to, with the modeling unit 114, model the real space based on the recognized empty region. By repeating, the remaining region can be sufficiently reduced.
(8) The robot system 1 according to (7), wherein, after the remaining region has been reduced until the predetermined condition is satisfied, the control unit 113 is configured to control the robot 2 so as to direct the sensor 3 toward the remaining region, and the recognition unit 111 is configured to recognize a new empty region in the remaining region based on the three-dimensional data acquired by the sensor 3 directed toward the remaining region.

By sufficiently reducing the remaining region and acquiring three-dimensional data focusing on the remaining region, the remaining region can be reduced more efficiently.
(9) The robot system 1 according to (8), wherein the control unit 113 is configured to control the robot 2 so as to direct the sensor 3 toward the remaining region from a plurality of locations, and wherein the recognition unit 111 is configured to recognize a new empty region in the remaining region based on a plurality of sets of three-dimensional data acquired by the sensor 3 directed toward the remaining region from the plurality of locations.

By using a plurality of additional three-dimensional data acquired from a plurality of locations for the common remaining region, the remaining region can be reduced more efficiently.
(10) The robot system 1 according to any one of (1) to (9),

wherein the recognition unit 111 is configured to recognize, based on the three-dimensional data, that a region between the sensor 3 and the object is the empty region.

The empty region can be recognized with reliability and ease.
(11) The robot system 1 according to any one of (1) to (10),

wherein, when the three-dimensional data of the object cannot be acquired by the sensor 3, the recognition unit 111 is configured to recognize, as the empty region, a region from the sensor 3 to a predetermined detectable depth.

Even if the sensor 3 fails to acquire the three-dimensional data of the object, by recognizing that part of the region toward which the sensor 3 is directed is the empty region, the real space can be modeled more efficiently.
(12) The robot system 1 according to any one of (1) to (11), wherein the modeling unit 114 is configured to model the real space so that a region surrounded by the empty region is a region occupied by the object.

The arrangement of the object in the real space can be modeled with reliability.
(13) The robot system 1 according to any one of (1) to (12), wherein the control unit 113 is configured to control the robot 2 to execute a task in cooperation with the object disposed in the real space based on a modeling result of the real space by the modeling unit 114.
(14) A modeling method comprising: recognizing, based on three-dimensional data of an object disposed in a real space acquired by a sensor 3, an empty region in the real space where the object does not exist; controlling a robot 2 so as to dispose the sensor 3 in the empty region; recognizing a new empty region based on the three-dimensional data newly acquired by the sensor 3 disposed in the empty region; and modeling the real space based on the empty region in which the sensor 3 is disposed and the new empty region.

It is to be understood that not all aspects, advantages and features described herein may necessarily be achieved by, or included in, any one particular example. Indeed, having described and illustrated various examples herein, it should be apparent that other examples may be modified in arrangement and detail.

What is claimed is:

1. A robot system comprising:
a sensor configured to acquire three-dimensional data of an object disposed in a real space;
a robot configured to change a position of the sensor;
circuitry configured to:
recognize, based on three-dimensional first data acquired by the sensor, an empty region in the real space where the object does not exist;
control the robot so as to dispose the sensor in the empty region; and
model the real space based on recognized empty regions including the empty region and a new empty region, the new empty region recognized based on three-dimensional second data newly acquired by the sensor from the empty region.

2. The robot system according to claim 1, wherein the circuitry is configured to:
change a posture of the sensor within the empty region by the robot, and recognize the new empty region based on the second data acquired at a plurality of postures of the sensor within the empty region.

3. The robot system according to claim 2, wherein the robot comprises:
an end part to which the sensor is fixed;
an arm connected to the end part and configured to change a position of the end part; and
one or more wrist axes configured to change the posture of the end part with respect to the arm, and
wherein the circuitry is configured to operate the one or more wrist axes so as to change the posture of the sensor within the empty region while keeping the arm at an identical posture.

4. The robot system according to claim 3, wherein the circuitry is configured to:
operate the one or more wrist axes so as to change the posture of the sensor disposed at an initial position before the empty region is recognized; and
recognize the empty region based on the first data acquired at a plurality of postures of the sensor at the initial position.

5. The robot system according to claim 3, wherein the circuitry is configured to:
specify, within the empty region, a position of the sensor where the sensor does not move out of the empty region even when the one or more wrist axes are operated in accordance with a predetermined motion pattern;
operate the arm so as to dispose the sensor at the specified position; and
operate the one or more wrist axes in accordance with the motion pattern so as to change the posture of the sensor within the empty region.

6. The robot system according to claim 5, wherein the circuitry is configured to calculate a sensor occupation region with respect the position of the sensor, the sensor occupation region being occupied by the sensor during operation of the one or more wrist axes in accordance with the motion pattern; and
specify the position of the sensor so that the sensor occupation region is contained within the empty region.

7. The robot system according to claim 3, wherein the circuitry is configured to:
generate a motion pattern of the one or more wrist axes so as to change the posture of the sensor disposed in the empty region, without causing the sensor to move out of the empty region; and
operate the one or more wrist axes in accordance with the generated motion pattern so as to change the posture of the sensor within the empty region.

8. The robot system according to claim 1, wherein the circuitry is further configured to:
determine, after the new empty region has been recognized, whether a remaining region of the real space is reduced until a predetermined condition is satisfied, the remaining region being a region where it is not specified whether the region is occupied by an object;
control, in response to determining that the remaining region is not reduced until the predetermined condition is satisfied, the robot so as to dispose the sensor in the new empty region;
recognize additional new empty region based on additional second data newly acquired by the sensor from the new empty region;
redetermine, after the additional new empty region has been recognized, whether the remaining region of the real space is reduced until the predetermined condition is satisfied; and
model, in response to determining that the remaining region is reduced until the predetermined condition is satisfied, the real space based on the recognized empty regions further including the additional new empty region.

9. The robot system according to claim 8, wherein the predetermined condition includes that a volume of the remaining region is equal to or less than a predetermined threshold.

10. The robot system according to claim 8, wherein the circuitry is further configured to:
control, after the remaining region has been reduced until the predetermined condition is satisfied, the robot so as to direct the sensor toward the remaining region;
recognize a remaining empty region in the remaining region based on three-dimensional third data acquired by the sensor directed toward the remaining region; and
model the real space based on the recognized empty regions further including the remaining empty region.

11. The robot system according to claim 10, wherein the circuitry is configured to:
control the robot so as to direct the sensor toward the remaining region from a plurality of locations; and
recognize the remaining empty region in the remaining region based on the third data acquired by the sensor directed toward the remaining region from the plurality of locations.

12. The robot system according to claim 1, wherein the circuitry is configured to recognize, based on the three-dimensional data, that a region between the sensor and the object is the empty region.

13. The robot system according to claim 12, wherein the circuitry is configured to recognize, as the empty region, a region from the sensor to a predetermined detectable depth, in response to determining that the three-dimensional data of the object cannot be acquired by the sensor.

14. The robot system according to claim 1, wherein the circuitry is configured to model the real space so that a region surrounded by the recognized empty regions is a region occupied by the object.

15. The robot system according to claim 1, wherein the circuitry is configured to control the robot to execute a task in cooperation with the object disposed in the real space, based on a modeling result of the real space.

16. A modeling method comprising:
recognizing, based on three-dimensional first data of an object disposed in a real space acquired by a sensor, an empty region in the real space where the object does not exist;
controlling a robot so as to dispose the sensor in the empty region;
recognizing a new empty region based on three-dimensional second data newly acquired by the sensor disposed in the empty region;
and modeling the real space based on recognized empty regions including the empty region and the new empty region.

17. The modeling method according to claim 16, further comprising changing a posture of the sensor within the empty region by the robot, wherein the new empty region is recognized based on the second data acquired at a plurality of postures of the sensor within the empty region.

18. The modeling method according to claim 16, wherein said modeling comprises:
determining, after the new empty region has been recognized, whether a remaining region of the real space is reduced until a predetermined condition is satisfied, the remaining region being a region where it is not specified whether the region is occupied by an object;
controlling, in response to determining that the remaining region is not reduced until the predetermined condition is satisfied, the robot so as to dispose the sensor in the new empty region;
recognizing additional new empty region based on additional second data newly acquired by the sensor from the new empty region;
redetermining, after the additional new empty region has been recognized, whether the remaining region of the real space is reduced until the predetermined condition is satisfied; and
modelling, in response to determining that the remaining region is reduced until the predetermined condition is satisfied, the real space based on the recognized empty regions further including the additional new empty region.

19. The modeling method according to claim 18, wherein said modeling comprises:
controlling, after the remaining region has been reduced until the predetermined condition is satisfied, the robot so as to direct the sensor toward the remaining region;
recognizing a remaining empty region in the remaining region based on three-dimensional third data acquired by the sensor directed toward the remaining region; and
modelling the real space based on the recognized empty regions further including the remaining empty region.

20. A non-transitory memory device having instructions stored thereon that, in response to execution by a processing device, cause the processing device to perform operations comprising:
recognizing, based on three-dimensional first data of an object disposed in a real space acquired by a sensor, an empty region in the real space where the object does not exist;
controlling a robot so as to dispose the sensor in the empty region;
recognizing a new empty region based on three-dimensional second data newly acquired by the sensor disposed in the empty region; and
modeling the real space based on recognized empty regions including the empty region and the new empty region.
